(19) United States
(12) Patent Application Publication
(10) Pub. No.: US 2008/0133199 A1
(43) Pub. Date: Jun. 5, 2008

(54) Apparatus and method for detecting ligand by using automatic specific site extraction

(75) Inventors: Sung-Hee Park, Daejon (KR); Chan-Yong Park, Daejon (KR); Dae-Hee Kim, Daejon (KR); Soo-Jun Park, Seoul (KR); Seon-Hee Park, Daejon (KR)

Correspondence Address: BLAKELY SOKOLOFF TAYLOR & ZAFMAN, 1279 OAKMEAD PARKWAY, SUNNYVALE, CA, 94085-4040, US

(73) Assignee: Electronics and Telecommunications Research Institute

(21) Appl. No.: 11/978,830

(22) Filed: Oct. 30, 2007

(30) Foreign Application Priority Data
Dec. 4, 2006 (KR) 10-2006-0121753

(51) Int. Cl. G06G 7/48

(52) U.S. Cl. 703/11

(57) ABSTRACT

Provided is an apparatus and method for detecting a ligand through automatic specific site extraction and allow a convenient and speedy protein structure-based drug design by detecting sequences and structures of protein binding sites or detecting structures of protein binding sites, and then automatically extracting a specific site to detect a ligand. The ligand detecting apparatus includes: an input data processing unit for processing input data; a binding site extraction unit for extracting a binding site from the data; a user input unit for allowing a user to select a comparison type; a manual like-binding-site comparison unit for manually comparing a binding site of a target protein with a like binding site of a protein of a database to extract a specific site; an automatic like-binding-site comparison unit; and a ligand detection unit for performing virtual screening on the specific site.

### CROSS-REFERENCE(S) TO RELATED APPLICATIONS

The present invention claims priority of Korean Patent Application No. 10-2006-0121753, filed on Dec. 4, 2006, which is incorporated herein by reference.

### BACKGROUND OF THE INVENTION

1. Field of the Invention

The present invention relates to an apparatus and method for detecting a ligand by using automatic specific site extraction; and, more particularly, to an apparatus and method for detecting a ligand by using automatic specific site extraction, which are configured to design a drug with high selectivity, and allow a convenient and speedy protein structure-based drug design by detecting sequences and structures of protein binding sites or detecting structures of protein binding sites, and then automatically extracting a specific site to detect a ligand.

This work was supported by the Information Technology (IT) research and development program of the Korean Ministry of Information and Communication (MIC) and/or the Korean Institute for Information Technology Advancement (IITA) [2005-S-008-02, “SW Component Development of Bio Data Mining & Integrated Management”].

2. Description of Related Art

First, terms used in the present invention will be briefly defined below.

A ligand refers to a small compound.

A leading material refers to a ligand that has a high possibility of becoming a good drug.

A target protein refers to a protein which a new drug design is aimed at.

In general, a structure based drug design begins with the assumption that a structure of a target protein has already been learned. The structure based drug design employs a method of detecting a drug binding site of the target protein and detecting a leading material with selectively high-affinity with respect to the binding site.

After the leading material is detected, candidate new drugs are developed. However, many candidate new drugs have side effects and toxicity, and a study has suggested that such side effects and toxicity occur because of low selectivity of the drugs. That is, it is important to design a drug with high selectivity, which binds only to a target protein, not to other proteins.

In order to design such a drug with high selectivity, in the conventional art, distinctive residues or atoms of a like binding site of a protein which is similar to a binding site of a target protein are detected manually or with the naked eye.

To this end, a designer compares the like binding site with the binding site of the target protein, looking at a computer screen for a long time. This operation requires much effort, but there is always a possibility of missing a difference therebetween.

In general, to compare binding sites of proteins, a difference therebetween may be 3-dimensionally detected by using sequence alignment.

However, this method has limitations in which positions vary even if the sequence is the same.

### SUMMARY OF THE INVENTION

An embodiment of the present invention is directed to providing an apparatus and method for detecting a ligand by using automatic specific site extraction, which are configured to design a drug with high selectivity and allow a convenient and speedy protein structure-based drug design, by detecting sequences and structures of protein binding sites and automatically extracting a specific site to detect a ligand.

Another embodiment of the present invention is directed to providing an apparatus and method for detecting a ligand by using automatic specific site extraction, which are configured to design a drug with high selectivity and allow a convenient and speedy protein structure-based drug design by detecting structures of protein binding sites and automatically extracting a specific site to detect a ligand.

In accordance with an aspect of the present invention, there is provided an apparatus for detecting a ligand by using automatic specific site extraction, which includes: an input data processing unit for processing input data; a binding site extraction unit for extracting a binding site from the data processed by the input data processing unit; a user input unit for allowing a user to select a comparison type; a manual like-binding-site comparison unit for manually comparing a binding site of a target protein and a like binding site of a protein of a database to extract a specific site; an automatic like-binding-site comparison unit for automatically comparing a binding site of a target protein with a like binding site of a protein of the database to extract a specific site; and a ligand detection unit for performing virtual screening on the specific site detected by the manual like-binding-site comparison unit or the automatic like-binding-site comparison unit.

In accordance with another aspect of the present invention, there is provided a method for detecting a ligand by using automatic specific site extraction, which includes the steps of: a) extracting a binding site from input protein; b) checking whether a manual comparison type or an automatic comparison type is selected; c) manually comparing a binding site of a target protein with a like binding site of a protein of a database when the manual comparison type is selected, to extract a specific site; d) automatically comparing a binding site of a target protein with a like binding site of a protein of the database when the automatic comparison type is selected, to extract a specific site; and e) performing virtual screening on the specific site extracted in the manually comparing step c) or the automatically comparing step d).

In accordance with another aspect of the present invention, there is provided an apparatus for detecting a ligand by using automatic specific site extraction unit, which includes: an input data processing unit for processing input data; a binding site extraction unit for extracting a binding site from the data of the input data processing unit; a like-binding-site structure detection unit for detecting like binding sites similar to a binding site of a target protein while examining protein structures of an external protein structure database for using the binding site extracted by the binding site extraction unit; an automatic specific-site extraction unit for automatically extracting a specific binding site with respect to the binding site extracted by the binding site extraction unit and the like binding site detected by the like-binding-site structure detection unit; and a ligand detection unit for performing virtual screening on the specific site extracted by the automatic specific-site extraction unit to detect a ligand.

In accordance with another aspect of the present invention, there is provided a method for detecting a ligand by using automatic specific site extraction, the method which includes: a) extracting a binding site from an input protein; b) detecting like binding sites similar to a binding site of a target protein while examining protein structures of an external protein structure database, using the binding site extracted in the binding-site extracting step a); c) automatically extracting a specific site with respect to the binding site extracted in the binding-site extracting step a) and the like binding site detected in the like-binding-site detecting step b); and d) performing virtual screening on the specific site extracted in the automatically extracting step c) to detect a ligand.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### BRIEF DESCRIPTION OF THE DRAWINGS

FIG. 1 is a block diagram of an apparatus for detecting a ligand by using automatic specific site extraction in accordance with an embodiment of the present invention.

FIG. 2 is a flowchart of a method for detecting a ligand by using automatic specific site extraction in accordance with an embodiment of the present invention.

FIG. 3 is a block diagram of an apparatus for detecting a ligand by using automatic specific site extraction in accordance with another embodiment of the present invention.

FIG. 4 is a view for explaining an apparatus for detecting a ligand by using automatic specific site extraction in accordance with an embodiment of the present invention.

FIG. 5 is a flowchart of a method for detecting a ligand by using automatic specific-site extraction in accordance with another embodiment of the present invention.

### DESCRIPTION OF SPECIFIC EMBODIMENTS

The advantages, features and aspects of the invention will become apparent from the following description of the embodiments with reference to the accompanying drawings, which is set forth hereinafter.

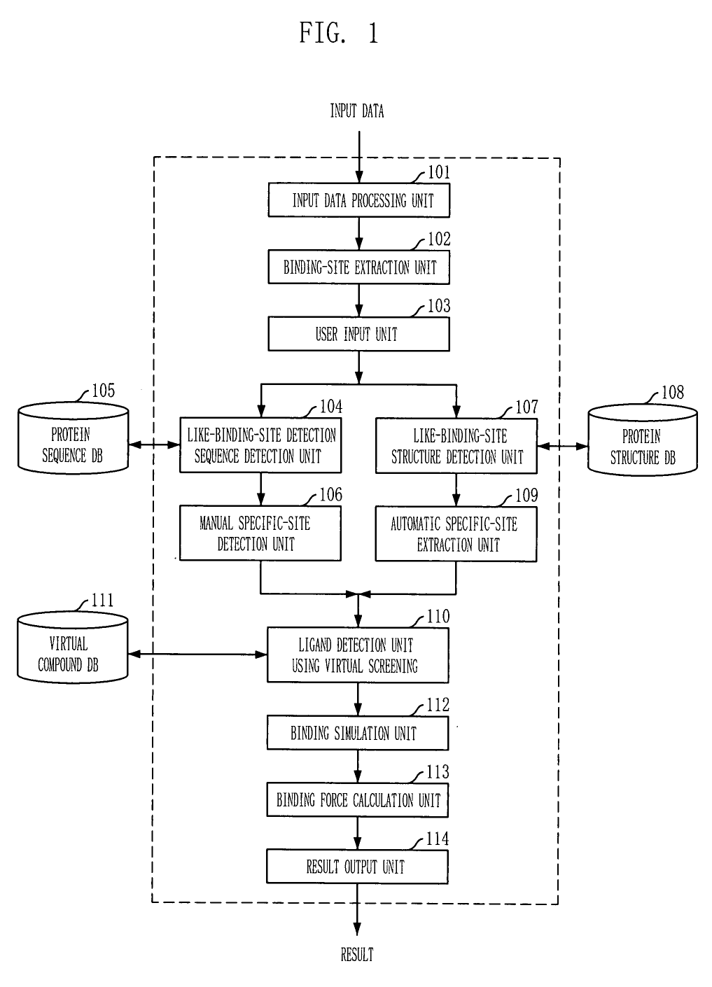

FIG. 1 is a block diagram of an apparatus for detecting a ligand by using automatic specific site extraction in accordance with an embodiment of the present invention.

Referring to FIG. 1, the apparatus for detecting a ligand by using automatic specific site extraction in accordance with an embodiment of the present invention is a combination of an existing sequence detection type ligand detection apparatus, and a user input unit 103, a like-binding-site structure detection unit 107, an automatic specific-site extraction unit 109, and a ligand detection unit 107 using virtual screening. The existing sequence detection type ligand detection apparatus includes an input data processing unit 101, a binding-site extraction unit 102, a like-binding-site sequence detection unit 104, a manual specific-site detection unit 106, a binding simulation unit 112, a binding force calculation unit 113, and a result output unit 114. Thus, the apparatus for detecting a ligand by using automatic specific site extraction in accordance with an embodiment of the present invention is implemented to detect structures of binding sites of proteins as well as sequences thereof, and automatically extracting a specific site to detect a ligand.

The binding simulation unit 112, the binding force calculation unit 113, and the result output unit 114 are for checking a binding force of a detected ligand, and are further elements in the present invention.

In detail, referring to FIG. 1, the apparatus for detecting a ligand by using automatic specific site extraction in accordance with the present invention includes the input data processing unit 101, the binding site extraction unit 102, the user input unit 103, a manual like-binding-site comparison unit including the like-binding-site sequence detection unit 104 and the manual specific-site detection unit 106, an automatic like-binding-site comparison unit including the like-binding-site structure detection unit 107 and the automatic specific-site extraction unit 109, and the ligand detection unit 110.

The input data processing unit 101 processes input data (proteins). The binding site extraction unit 102 extracts candidate binding sites that are to bind to a drug from the data (protein) of the input data processing unit 101. The user input unit 103 performs support such that a user can select a comparison type. A manual like-binding-site comparison unit 104 and 106 manually compares a binding site of a target protein with a like binding site of a protein of a database to extract a specific site.

The automatic like-binding-site comparison unit 107 and 109 automatically compares a binding site of a target protein, and a like binding site of a protein of the database to extract a specific site. The ligand detection unit 110 performs virtual screening on the specific site detected by the manual like-binding-site comparison unit 104 and 106, or the automatic like-binding-site comparison unit 107 and 109, thereby detecting a ligand.

The apparatus for detecting a ligand by using automatic binding site extraction in accordance with an embodiment of the present invention further includes the binding simulation unit 112, the binding-force calculation unit 113, and the result output unit 114. The binding simulation unit 112 performs a binding simulation on the target protein and the ligand detected by the ligand detection unit 110 through the virtual screening. The calculation unit 113 calculates a binding force of simulated binding obtained by the binding simulation unit 112. The result output unit 114 outputs a result in the form desired by a user.

The like-binding-site sequence detection unit 104 of the manual like-binding-site comparison unit automatically compares binding sites by using an external protein sequence database 105 and an automatic sequence algorithm to detect a difference between sequences. The manual specific-site detection unit 106 provides a user with the detected difference between sequences to support user's manual detection of a specific site.

The like-binding-site structure detection unit 107 of the automatic like-binding-site comparison unit detects like binding sites similar to a binding site of the target protein while examining a structure of each protein of an external protein structure DB 108 using a binding site extracted from the binding-site extraction unit 102. The automatic specific-site extraction unit 109 automatically extracts a specific site with respect to the binding site extracted by the binding site extraction unit 102 and the like binding site detected by the like-binding-site structure detection unit 107. For example, the automatic specific-site extraction unit 109 automatically detects a protein-specific site by protein-volume detailed comparison.

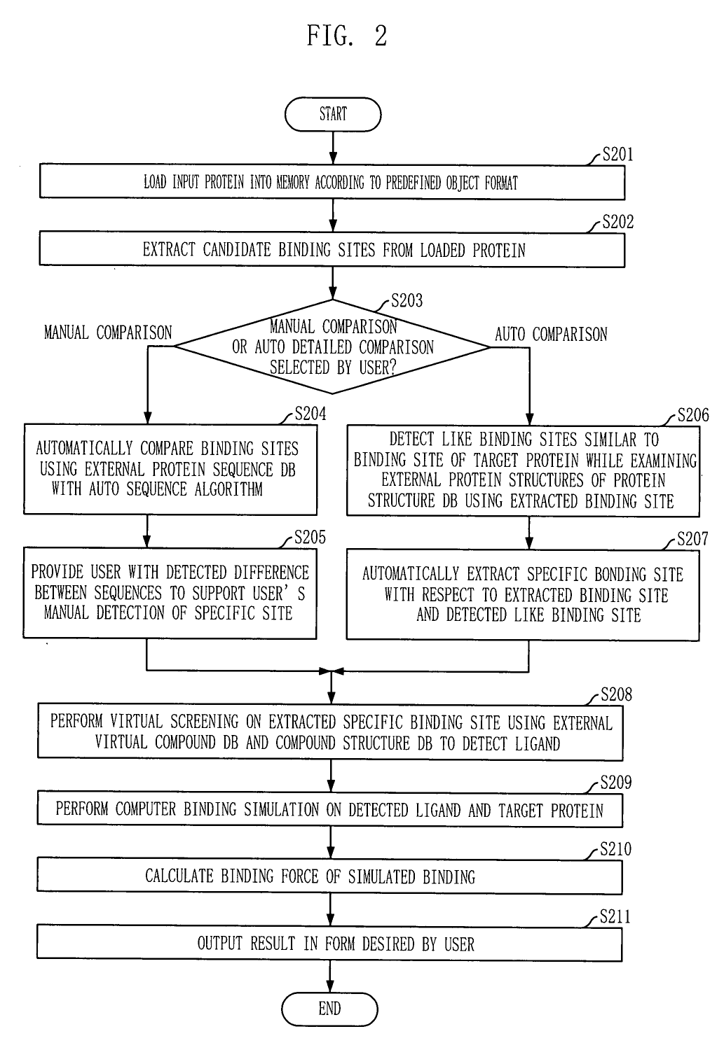

The operation of the apparatus for detecting a ligand by using automatic specific site extraction in accordance with one embodiment of the present invention will now be described in more detail with reference to FIG. 2.

FIG. 2 is a flowchart of a method for detecting a ligand by using automatic binding site extraction in accordance with an embodiment of the present invention.

In step S201, the input data processing unit 101 loads an input protein into a memory according to a predefined object format.

In step S202, the binding-site extraction unit 102 extracts candidate binding sites that are to bind to a drug, by using a method of detecting an atom and a residue recessed in the form of a pocket or cavity from the protein loaded by the input data processing unit 101.

In step S203, the user selection unit 103 performs support such that a user can select one of a manual comparison type and an automatic comparison type to be described later, and then checks the comparison type selected by the user.

In steps S204 and 205, when the user selects the manual comparison type in step S203, a binding site of a target protein is manually compared with a like binding site of a protein of a database to extract a specific site. In detail, in step S204, the like-binding site sequence detection unit 104 automatically compares binding sites by using the external protein sequence database 105 and the automatic sequence algorithm, and detects a difference between sequences. Information of the detected difference is transferred to the manual specific-site detection unit 106. Then, the manual specific-site detection unit 106 provides a user with various user interfaces allowing manual detection of the specific-site, and a monitor and a method for allowing three-dimensional visualization. In step S205, the manual specific-site detection unit 106 provides the user with the sequence difference detected by the like-binding-site sequence detection unit 104, and supports the user's manual detection of a specific site.

In steps S206 and S207, when the user selects the automatic comparison type in step S203, a binding site of the target protein is automatically compared with a like binding site of a protein of the database to extract a specific site. In detail, in step S206, the like-binding-site structure detection unit 107 detects light binding sites similar to a binding site of the target protein while examining a structure of each protein of the external protein structure database 108, using the binding site extracted by the binding-site extraction unit 102.

In step S207, the automatic specific-site extraction unit 109 automatically extracts a specific site with respect to the binding site extracted by the binding-site extraction unit 102 and the like binding sites detected by the like-binding site structure detection unit 107. That is, the automatic specific-site extraction unit 109 aligns the binding site extracted by the binding-site extraction unit 102 with the like binding sites detected by the like-binding-site structure detection unit 107, and then extracts a specific position of a binding site by detecting a distinctive part of the binding site in the aligned structure. The extracted specific site is used as very important information when the ligand detection unit 110 detects a protein-specific ligand using virtual screening.

In step S208, the ligand detection unit 110 using virtual screening performs virtual screening on the specific site detected by the manual specific-site detection unit 106 or the automatic specific-site extraction unit 108 by using compound structure data of an external virtual compound database 111 called a compound bank, that is, a virtual compound structure library.

The ligand detection unit 110 detects a compound that binds with high affinity to the specific site determined by the manual specific-site detection unit 106 or the automatic specific site extraction unit 108, that is, a compound fitting in a pocket of a protein, from hundreds of thousands of compound structure data (leading material) stored in the virtual compound database 111.

In step S209, the binding simulation unit 112 performs a computer binding simulation on the target protein and the ligand detected by the ligand detection unit 110.

In step S210, the binding-force calculation unit 113 calculates a binding force of simulated binding obtained by the binding simulation unit 112. Additionally, the binding force may be output to a user, and when the output binding force is less than a desired binding force, the operation may be repeated from step S203 of inputting user's selection, such that comparison can be performed on another candidate binding site.

In step S211, the result output unit 114 outputs a result in the form desired by a user. That is, the result is transmitted to an external device such as a monitor and a printer. Of course, after the result is output in step S211, the operation may be repeated from step S203 of inputting user's selection so that comparison can be additionally performed on another candidate binding site, without performing an additional process (feedback process) of the binding-force calculation unit 113.

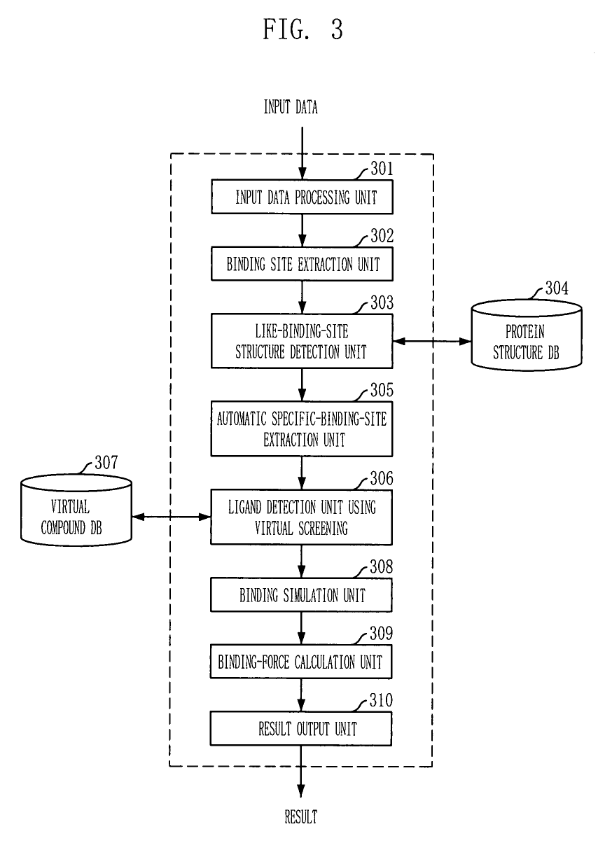

FIG. 3 is a block diagram of an apparatus for detecting a ligand by using automatic specific site extraction in accordance with another embodiment of the present invention.

Referring to FIG. 3, the apparatus for detecting a ligand by using automatic specific-site extraction in accordance with another embodiment of the present invention includes an input data processing unit 301, a binding-site extraction unit 302, a like-binding-site structure detection unit 303, an automatic specific-site extraction unit 305, and a ligand detection unit 306 using virtual screening. The data processing unit 301 processes input data (protein).

The binding-site extraction unit 302 extracts candidate binding sites that are to bind to a drug from the data (protein) of the input data processing unit. The like-binding-site structure detection unit 303 detects like binding sites similar to a binding site of a target protein while examining a structure of each protein of an external protein structure database 304 by using the binding site extracted by the binding-site extraction unit 302.

The automatic specific-site extraction unit 305 automatically extracts a specific site with respect to the binding site extracted by the binding site extraction unit 302, and the like binding site detected by the like-binding-site structure detection unit 303. The ligand detection unit 306 performs virtual screening on the specific site extracted by the automatic specific-site extraction unit 305 to detect a ligand.

The apparatus for detecting a ligand by using automatic specific-site extraction in accordance with another embodiment of the present invention further includes a binding simulation unit 308, a binding force calculation unit 309, and a result output unit 310. The binding simulation unit 308 performs a binding simulation on the target protein and the ligand detected by the ligand detection unit 306 using the virtual screening. The binding force calculation unit 309 calculates a binding force of simulated binding obtained by the binding simulation unit 308. The result output unit 310 outputs a result in the form desired by a user.

The ligand detection unit 306 using the virtual screening detects a ligand by performing virtual screening on the specific site extracted by the automatic specific-site extraction unit 305, using compound structure data of an external virtual compound database 307 called a compound bank, that is, a virtual compound structure library.

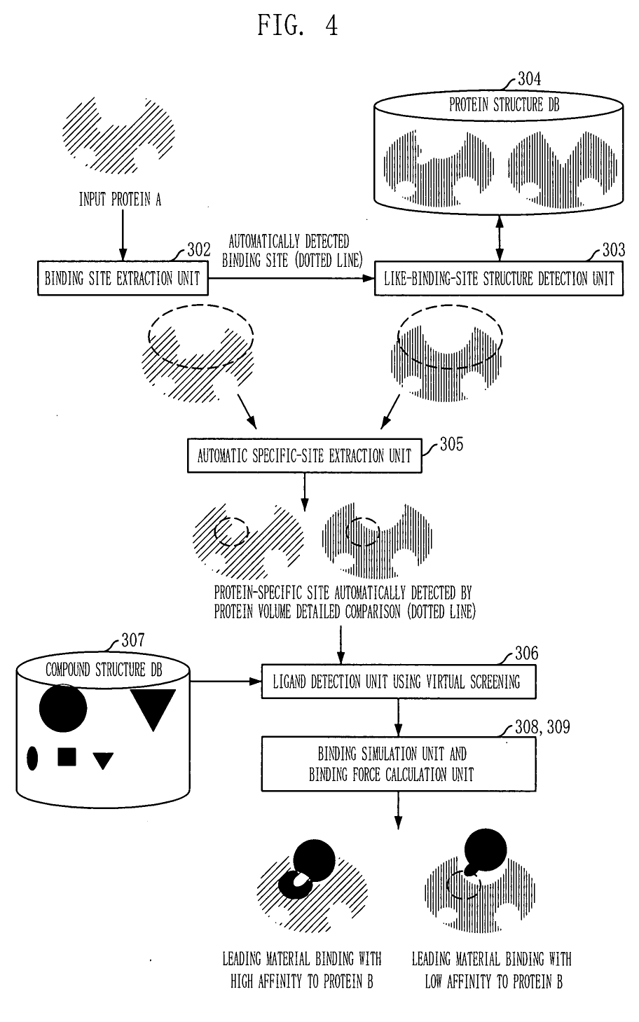

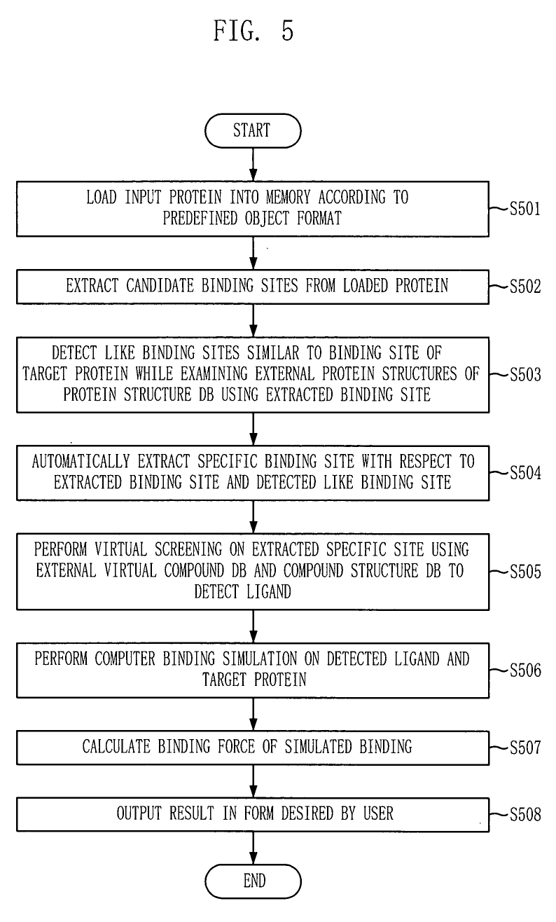

An operation of the apparatus for detecting a ligand by using automatic specific-site extraction in accordance with another embodiment of the present invention will now be described in more detail with reference FIGS. 4 and 5.

FIG. 4 is a view for explaining an apparatus for detecting a ligand by using automatic specific site extraction in accordance with another embodiment of the present invention. FIG. 5 is a flowchart of a method for detecting a ligand by using automatic specific site extraction in accordance with another embodiment of the present invention.

In step S501, the input data processing unit 301 loads an input protein into a memory according to a predefined object format.

In step S502, the binding-site extraction unit 302 extracts candidate binding sites that are to bind to a drug from the protein loaded by the input data processing unit 301, by using a method of detecting an atom and a residue recessed in the form of a pocket or a cavity.

In steps S503 and S504, a binding site of a target protein is automatically compared with a like binding site of a protein of a database to extract a specific site. In detail, in step S503, the like-binding-site structure detection unit 303 detects like binding sites similar to a binding site of a target protein while examining a structure of each protein of the external protein structure database 304, using the binding site extracted by the binding-site extraction unit 302.

In step S504, the automatic specific-site extraction unit 305 automatically extracts a specific site with respect to the binding site extracted by the binding-site extraction unit 302, and the like binding sites detected by the like-binding-site structure detection unit 303. That is, the automatic specific-site extraction unit 305 aligns the binding site extracted by the binding-site extraction unit 302 with the like binding sites detected by the like-binding-site detection unit 303, and then detects a distinctive part of the binding site in the aligned structure to extract a specific position of the binding site.

The specific site extracted in such a manner is used as very important information in detecting a protein-specific ligand by the ligand detection unit 306 using virtual screening.

In step S505, the ligand detection unit 306 using virtual screening detects a ligand by performing virtual screening on the specific site extracted by the automatic specific-site detection unit 305, using a compound structure of the external virtual compound database 307 called a compound bank. The ligand detection unit 306 detects a compound that binds with high-affinity to the specific site extracted by the automatic specific site extraction unit 305, that is, a compound fitting in a pocket of a protein, from hundreds of thousands of compound structure data (leading material) stored in the virtual compound database 307.

In step S506, the binding simulation unit 308 performs a computer binding simulation on the target protein and the ligand detected by the ligand detection unit 306.

In step S507, the binding-force calculation unit 309 calculates a binding force of simulated binding obtained by the binding simulation unit 308. Additionally, the binding force may be output to a user, and when a binding force is lowered than a desired binding force, the operation may be repeated from step S502 of extracting the candidate binding sites so that comparison can be performed on another candidate binding site.

In step S508, the result output unit 310 outputs a result in the form desired by a user. That is, the result is output to an external device such as a monitor and a printer. Of course, without performing an additional process (feedback process) of the binding-force calculation unit 309, the operation may repeated from step S502 of extracting the candidate binding sites after the result is output in step S508, so that comparison can be performed on another candidate binding site.

Structures and sequences of protein binding sites are detected, or structures of the protein binding sites are detected, and then a specific site is automatically extracted, thereby detecting a ligand. Accordingly, a drug with high selectivity can be designed, and a protein structure-based drug design can be speedily and conveniently performed.

The methods in accordance with the embodiments of the present invention can be realized as programs and stored in a computer-readable recording medium that can execute the programs. Examples of the computer-readable recording medium include CD-ROM, RAM, ROM, floppy disks, hard disks, magneto-optical disks and the like.

While the present invention has been described with respect to the specific embodiments, it will be apparent to those skilled in the art that various changes and modifications may be made without departing from the spirit and scope of the invention as defined in the following claims.

What is claimed is:

1. An apparatus for detecting a ligand by using automatic specific site extraction, comprising:
an input data processing unit for processing input data;
a binding site extraction unit for extracting a binding site from the data processed by the input data processing unit;
a user input unit for allowing a user to select a comparison type;
a manual like-binding-site comparison unit for manually comparing a binding site of a target protein with a like binding site of a protein of a database to extract a specific site;
an automatic like-binding-site comparison unit for automatically comparing a binding site of a target protein with a like binding site of a protein of the database to extract a specific site; and
a ligand detection unit for performing virtual screening on the specific site detected by the manual like-binding-site comparison unit or the automatic like-binding-site comparison unit.

2. The apparatus of claim 1, wherein the automatic like-binding-site comparison unit comprises:
a like-binding-site structure detection unit for detecting like binding sites similar to the binding site of the target protein while examining protein structures of an external protein structure database, using the binding site extracted by the binding-site extraction unit; and
an automatic specific-site extraction unit for automatically extracting the specific site with respect to the binding site extracted by the binding-site extraction unit and the like binding sites detected by the like-binding-site structure detection unit.

3. The apparatus of claim 2, wherein the automatic specific-site extraction unit aligns the binding site extracted by the binding-site extraction unit and the like binding sites detected by the like-binding-site structure detection unit, and then detects a distinctive part of the binding site in the aligned structure to extract a specific position of the binding site.

4. The apparatus of claim 2, wherein the manual like-binding-site comparison unit comprises:
a like-binding-site sequence detection unit for automatically comparing binding sites by using an external protein sequence database and an automatic sequence algorithm to detect a difference between sequences; and
a manual specific-site detection unit for providing a user with the difference between sequences detected by the like-binding-site sequence detection unit to support user's manual detection of the specific site.

5. The apparatus of claim 1, further comprising:
a binding simulation unit for performing a binding simulation on the target protein and the ligand detected by the ligand detection unit;
a binding-force calculation unit for calculating a binding force of simulated binding obtained by the binding simulation unit; and
a result output unit for outputting a result in the form desired by a user.

6. A method for detecting a ligand by using automatic specific site extraction, comprising the steps of:
a) extracting a binding site from input protein;
b) checking whether a manual comparison type or an automatic comparison type is selected;
c) manually comparing a binding site of a target protein with a like binding site of a protein of a database when the manual comparison type is selected, to extract a specific site;
d) automatically comparing a binding site of a target protein with a like binding site of a protein of the database when the automatic comparison type is selected, to extract a specific site; and
e) performing virtual screening on the specific site extracted in the manually comparing step c) or the automatically comparing step d).

7. The method of claim 6, wherein the automatically comparing step d) includes the steps of:
d1) detecting like binding sites similar to the binding site of the target protein while examining protein structures of an external protein structure database, using the binding site extracted in the extracting step a); and
d2) automatically extracting a specific site from the binding site extracted in the binding-site extracting step a) and the like binding site detected in the like-binding-site detecting step d1).

8. The method of claim 7, wherein the automatically extracting step d2) comprises:
d2-1) aligning the binding site extracted in the binding-site extracting step a) with the like binding sites detected in the like-binding-site detecting step d1), and detecting a distinctive part of the binding site in the aligned structure to extract a specific position of the binding site.

9. The method of claim 7, wherein the manually comparing step c) comprises:
c-1) automatically comparing binding sites by using an external protein sequence database and an automatic sequence algorithm to detect a difference between sequences; and
c-2) providing a user with the difference between sequences detected in the automatically comparing step c-1) to support user's manual detection of the specific site.

10. The method of claim 6, further comprising:
f) performing a binding simulation on the target protein and the ligand detected in the ligand detecting step e);
g) calculating a binding force of simulated binding obtained in the simulation performing step f); and
h) outputting a result in the form desired by the user.

11. The method of claim 10, further comprising:
i) repetitively performing the step b) to h) on another binding site from the checking step b).

12. An apparatus for detecting a ligand by using automatic specific site extraction unit, comprising:
an input data processing unit for processing input data;
a binding site extraction unit for extracting a binding site from the data of the input data processing unit;
a like-binding-site structure detection unit for detecting like binding sites similar to a binding site of a target protein while examining protein structures of an external protein structure database for using the binding site extracted by the binding site extraction unit;
an automatic specific-site extraction unit for automatically extracting a specific binding site with respect to the binding site extracted by the binding site extraction unit and the like binding site detected by the like-binding-site structure detection unit; and
a ligand detection unit for performing virtual screening on the specific site extracted by the automatic specific-site extraction unit to detect a ligand.

13. The apparatus of claim 12, wherein the automatic specific-site extraction unit aligns the binding site extracted by the binding site extraction unit with the like binding sites detected by the like-binding-site structure detection unit, and then detects a distinctive part of the binding site in the aligned structure to extract a specific position of the binding site.

14. The apparatus of claim 12, further comprising:
a binding simulation unit for performing a binding simulation on the target protein and the ligand detected by the ligand detection unit;
a binding-force calculation unit for calculating a binding force of simulated binding obtained by the binding simulation unit; and
a result output unit outputting a result in the form desired by a user.

15. A method for detecting a ligand by using automatic specific site extraction, the method comprising:
a) extracting a binding site from an input protein;
b) detecting like binding sites similar to a binding site of a target protein while examining protein structures of an external protein structure database, using the binding site extracted in the binding-site extracting step a);
c) automatically extracting a specific site with respect to the binding site extracted in the binding-site extracting step a) and the like binding site detected in the like-binding-site detecting step b); and
d) performing virtual screening on the specific site extracted in the automatically extracting step c) to detect a ligand.

16. The method of claim 15, wherein the automatically extracting step c) comprises:
c1) aligning the binding site extracted in the binding-site extracting step a) with the like binding sites detected in the like-binding-site detecting step b), and then detecting a distinctive part of the binding site in the aligned structure to extract a specific position of the binding site.

17. The method of claim 15, further comprising:
e) performing a binding simulation on the target protein and the ligand detected in the ligand detecting step d)
f) calculating a binding force of simulated binding obtained in the simulation performing step e); and
g) outputting a result in the form desired by a user.

18. The method of claim 17, further comprising:
h) repetitively performing the step b) to g) on another binding site from the binding-site extracting step a).
